(19) United States
(12) Patent Application Publication
(10) Pub. No.: US 2016/0359395 A1
(43) Pub. Date: Dec. 8, 2016

(54) MOTOR ASSEMBLY, INTEGRATED CIRCUIT AND APPLICATION DEVICE

(71) Applicant: Johnson Electric S.A., Murten (CH)

(72) Inventors: Chi Ping SUN, Hong Kong (CN); Shing Hin YEUNG, Hong Kong (CN); Fei XIN, Shen Zhen (CN); Ken WONG, Hong Kong (CN); Shu Juan HUANG, Shen Zhen (CN); Yun Long JIANG, Shen Zhen (CN); Yue LI, Hong Kong (CN); Bao Ting LIU, Shen Zhen (CN); En Hui WANG, Shen Zhen (CN); Xiu Wen YANG, Shen Zhen (CN); Li Sheng LIU, Shen Zhen (CN); Yan Yun CUI, Shen Zhen (CN)

(21) Appl. No.: 15/231,286

(22) Filed: Aug. 8, 2016

Related U.S. Application Data
(63) Continuation-in-part of application No. 14/822,353, filed on Aug. 10, 2015.
Application No. 14/822,353 is a continuation of application No. PCT/CN2015/086422, filed on Aug. 7, 2015.

(30) Foreign Application Priority Data
Aug. 8, 2014 (CN) 201410390592.2
Aug. 15, 2014 (CN) 201410404474.2
Jul. 5, 2016 (CN) 201610524458.6

(51) Int. Cl. H02K 11/04; H02P 6/26; H02M 7/06; H02K 11/215; H02K 21/12; H02P 6/16; H02K 1/27

(52) U.S. Cl. CPC H02K 11/04; H02P 6/16; H02P 6/26; H02K 1/2706; H02K 11/215; H02K 21/12; H02M 7/06; H02P 2207/05

(57) ABSTRACT

A motor assembly, an integrated circuit and an application device including the motor assembly are provided. The motor assembly includes a motor and a motor driving circuit, the motor driving circuit includes a step down circuit, and the step down circuit includes a first current branch and a second current branch which are turned on selectively. The step down circuit can be integrated in an application specific integrated circuit to reduce the complexity and cost of the circuit.

### CROSS REFERENCE TO RELATED APPLICATIONS

This application is a continuation-in-part of co-pending U.S. patent application Ser. No. 14/822,353, filed on Aug. 10, 2015, which claims priority under 35 U.S.C. §119(a) from Patent Application No. 201410390592.2 filed in the People's Republic of China on Aug. 8, 2014, and Patent Application No. 201410404474.2 filed in the People's Republic of China on Aug. 15, 2014. In addition, this application claims priority under 35 U.S.C. §119(a) from Patent Application No. PCTCN2015086422 as PCT application filed in Receiving Office of CN on Aug. 7, 2015, to Chinese Patent Application No. CN201610524458.6, filed with the Chinese Patent Office on Jul. 5, 2016, all of which are expressly incorporated herein by reference in their entireties and for all purposes.

### TECHNICAL FIELD

The present disclosure relates to the field of motor driving technology, and in particular to a motor assembly, an integrated circuit and an application device including the motor assembly.

### BACKGROUND

During starting of a synchronous motor, the stator produces an alternating magnetic field causing the permanent magnetic rotor to be oscillated. The amplitude of the oscillation of the rotor increases until the rotor begins to rotate, and finally the rotor is accelerated to rotate in synchronism with the alternating magnetic field of the stator. To ensure the starting of a conventional synchronous motor, a starting point of the motor is set to be low, which results in that the motor cannot operate at a relatively high working point, thus the efficiency is low. In another aspect, the rotor cannot be ensured to rotate in a same direction every time since a stop or stationary position of the permanent magnetic rotor is not fixed. Accordingly, in applications such as a fan and water pump, the impeller driven by the rotor has straight radial vanes, which results in a low operational efficiency of the fan and water pump.

FIG. 1 illustrates a conventional drive circuit for a synchronous motor, which allows a rotor to rotate in a same predetermined direction in every time it starts. In the circuit, a stator winding 1 of the motor is connected in series with a TRIAC between two terminals M and N of an AC power source VM, and an AC power source VM is converted by a conversion circuit DC into a direct current voltage and the direct current is supplied to a position sensor H. A magnetic pole position of a rotor in the motor is detected by the position sensor H, and an output signal Vh of the position sensor H is connected to a switch control circuit PC to control the bidirectional thyristor T.

FIG. 2 illustrates a waveform of the drive circuit. It can be seen from FIG. 2 that, in the drive circuit, no matter the bidirectional thyristor T is switched on or off, the AC power source supplies power for the conversion circuit DC so that the conversion circuit DC constantly outputs and supplies power for the position sensor H (referring to a signal VH in FIG. 2). In a low-power application, in a case that the AC power source is commercial electricity of about 200V, the electric energy consumed by two resistors R2 and R3 in the conversion circuit DC is more than the electric energy consumed by the motor.

The magnetic sensor applies Hall effect, in which, when current I runs through a substance and a magnetic field B is applied in a positive angle with respect to the current I, a potential difference V is generated in a direction perpendicular to the direction of current I and the direction of the magnetic field B. The magnetic sensor is often implemented to detect the magnetic polarity of an electric rotor.

As the circuit design and signal processing technology advances, there is a need to improve the magnetic sensor integrated circuit for the ease of use and accurate detection.

A motor can convert or transfer electrical energy based on the law of electromagnetic induction. A motor driving circuit is required to provide a drive signal for the motor. The motor driving circuit can be integrated in an application specific integrated circuit as much as possible, to reduce the complexity and cost of the circuit. A voltage drop resistor is required in some motor driving circuits. However, the voltage drop resistor cannot be integrated in the application specific integrated circuit usually.

### BRIEF DESCRIPTION OF THE DRAWINGS

In order to illustrate technical solutions in embodiments of the present disclosure or in the conventional technology more clearly, drawings used in the description of the embodiments or the conventional technology are introduced briefly hereinafter. Apparently, the drawings described hereinafter merely illustrate some embodiments of the present disclosure, and other drawings may be obtained by those skilled in the art based on these drawings without any creative efforts.

FIG. 1 illustrates a prior art drive circuit for a synchronous motor, according to an embodiment of the present disclosure;

FIG. 2 illustrates a waveform of the drive circuit shown in FIG. 1;

FIG. 3 illustrates a diagrammatic representation of a synchronous motor, according to an embodiment of the present disclosure;

FIG. 4 illustrates a block diagram of a drive circuit for a synchronous motor, according to an embodiment of the present disclosure;

FIG. 5 illustrates a drive circuit for a synchronous motor, according to an embodiment of the present disclosure;

FIG. 6 illustrates a waveform of the drive circuit shown in FIG. 5;

FIGS. 7 to 10 illustrate different embodiments of a drive circuit of a synchronous motor, according to an embodiment of the present disclosure;

FIG. 11 is a structural diagram of a motor assembly according to an embodiment of the present disclosure;

FIG. 12 is a structural diagram of a motor assembly according to another embodiment of the present disclosure;

FIG. 13 is a structural diagram of a motor assembly according to still another embodiment of the present disclosure;

FIG. 14 is a structural diagram of a motor in a motor assembly according to an embodiment of the present disclosure;

FIG. 15 is a structural diagram of a motor assembly according to yet another embodiment of the present disclosure;

FIG. 16 is a structural diagram of a motor assembly according to yet another embodiment of the present disclosure;

FIG. 17 is a structural diagram of a switch control circuit in a motor assembly according to an embodiment of the present disclosure;

FIG. 18 is a structural diagram of a switch control circuit in a motor assembly according to another embodiment of the present disclosure;

FIG. 19 is a structural diagram of a switch control circuit in a motor assembly according to still another embodiment of the present disclosure;

FIG. 20 is a structural diagram of a switch control circuit in a motor assembly according to yet another embodiment of the present disclosure;

FIG. 21 is a structural diagram of a motor assembly according to yet another embodiment of the present disclosure;

FIG. 22 is a structural diagram of a rectifying circuit in a motor assembly according to an embodiment of the present disclosure;

FIG. 23 is a structural diagram of a rectifying circuit in a motor assembly according to another embodiment of the present disclosure; and

FIG. 24 is a diagram of a specific circuit of a motor assembly according to an embodiment of the present disclosure.

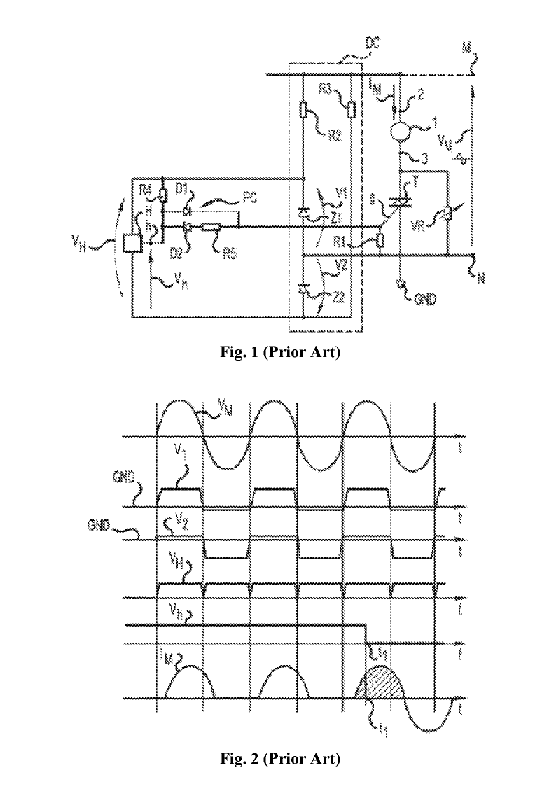

### DETAILED DESCRIPTION OF THE EMBODIMENTS

The technical solutions in embodiments of the present disclosure are clearly and completely described hereinafter in conjunction with the drawings in the embodiments of the present disclosure. Apparently, the described embodiments are only a few rather than all of the embodiments of the present disclosure. All other embodiments obtained by those skilled in the art based on the embodiments of the present disclosure without any creative efforts fall within the protection scope of the present disclosure.

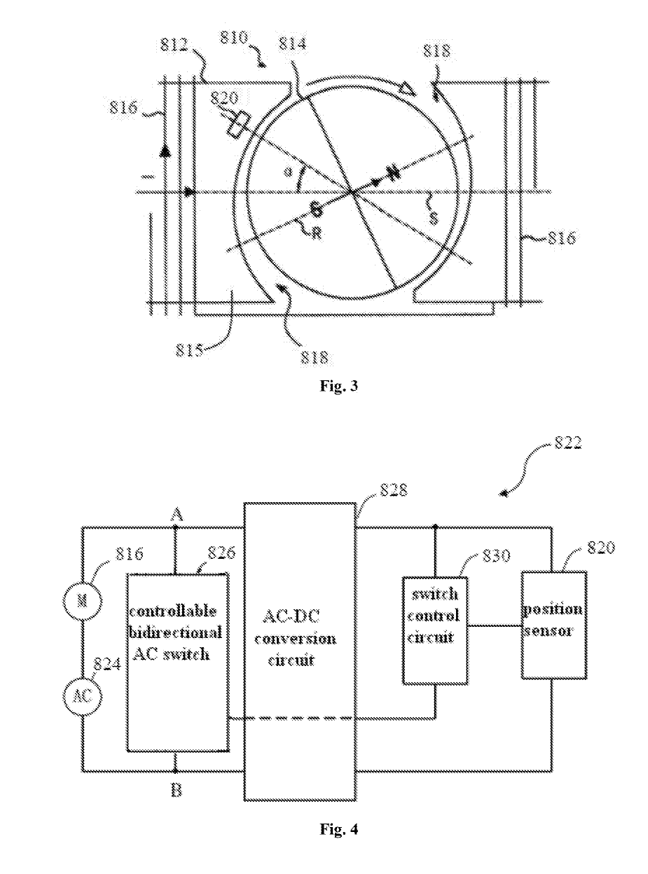

FIG. 3 schematically shows a synchronous motor according to an embodiment of the present invention. The synchronous motor 810 includes a stator 812 and a permanent magnet rotor 814 rotatably disposed between magnetic poles of the stator 812, and the stator 812 includes a stator core 815 and a stator winding 816 wound on the stator core 815. The rotor 814 includes at least one permanent magnet forming at least one pair of permanent magnetic poles with opposite polarities, and the rotor 814 operates at a constant rotational speed of 60 f/p rpm during a steady state phase in a case that the stator winding 816 is connected to an AC power supply, where f is a frequency of the AC power supply and p is the number of pole pairs of the rotor.

Non-uniform gap 818 is formed between the magnetic poles of the stator 812 and the permanent magnetic poles of the rotor 814 so that a polar axis R of the rotor 814 has an angular offset α relative to a central axis S of the stator 812 in a case that the rotor is at rest. The rotor 814 may be configured to have a fixed starting direction (a clockwise direction in this embodiment as shown by the arrow in FIG. 3) every time the stator winding 816 is energized. The stator and the rotor each have two magnetic poles as shown in FIG. 3. It can be understood that, in other embodiments, the stator and the rotor may also have more magnetic poles, such as 4 or 6 magnetic poles.

A position sensor 820 for detecting the angular position of the rotor is disposed on the stator 812 or at a position near the rotor inside the stator, and the position sensor 820 has an angular offset relative to the central axis S of the stator. Preferably, this angular offset is also α, as in this embodiment. Preferably, the position sensor 820 is a Hall effect sensor.

FIG. 4 shows a block diagram of a drive circuit for a synchronous motor according to an embodiment of the present invention. In the drive circuit 822, the stator winding 816 and the AC power supply 824 are connected in series between two nodes A and B. Preferably, the AC power supply 824 may be a commercial AC power supply with a fixed frequency, such as 50 Hz or 60 Hz, and a supply voltage may be, for example, 110V, 220V or 230V. A controllable bidirectional AC switch 826 is connected between the two nodes A and B, in parallel with the stator winding 816 and the AC power supply 824. Preferably, the controllable bidirectional AC switch 826 is a TRIAC, of which two anodes are connected to the two nodes A and B respectively. It can be understood that, the controllable bidirectional AC switch 826 alternatively may be two silicon control rectifiers reversely connected in parallel, and control circuits may be correspondingly configured to control the two silicon control rectifiers in a preset way. An AC-DC conversion circuit 828 is also connected between the two nodes A and B. An AC voltage between the two nodes A and B is converted by the AC-DC conversion circuit 828 into a low voltage DC. The position sensor 820 may be powered by the low voltage DC output by the AC-DC conversion circuit 828, for detecting the magnetic pole position of the permanent magnet rotor 814 of the synchronous motor 810 and outputting a corresponding signal. A switch control circuit 830 is connected to the AC-DC conversion circuit 828, the position sensor 820 and the controllable bidirectional AC switch 826, and is configured to control the controllable bidirectional AC switch 826 to be switched between a switch-on state and a switch-off state in a predetermined way, based on the magnetic pole position of the permanent magnet rotor which is detected by the position sensor and polarity information of the AC power supply 824 which may be obtained from the AC-DC conversion circuit 828, such that the stator winding 816 urges the rotor 814 to rotate only in the above-mentioned fixed starting direction during a starting phase of the motor. According to this embodiment of the present invention, in a case that the controllable bidirectional AC switch 826 is switched on, the two nodes A and B are shorted, the AC-DC conversion circuit 828 does not consume electric energy since there is no current flowing through the AC-DC conversion circuit 828, hence, the utilization efficiency of electric energy can be improved significantly.

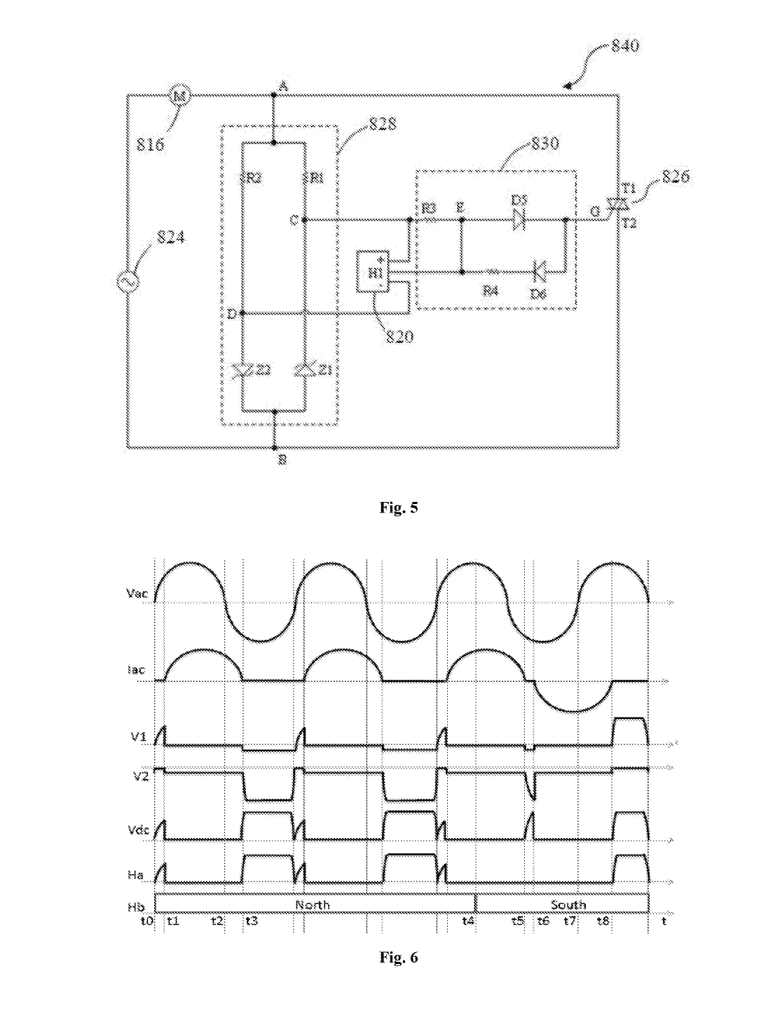

FIG. 5 shows a circuit diagram of a drive circuit 840 for a synchronous motor according to a first embodiment of the present disclosure. The stator winding 816 of the synchronous motor is connected in series with the AC power supply 824 between the two nodes A and B. A first anode T1 of the TRIAC 826 is connected to the node A, and a second anode T2 of the TRIAC 826 is connected to the node B. The AC-DC conversion circuit 828 is connected in parallel with the TRIAC 826 between the two nodes A and B. An AC voltage between the two nodes A and B is converted by the AC-DC conversion circuit 828 into a low voltage DC (preferably, low voltage ranges from 3V to 18V). The AC-DC conversion circuit 828 includes a first zener diode Z1 and a second zener diode Z2 which are reversely connected in parallel between the two nodes A and B via a first resistor R1 and a second resistor R2 respectively. A high voltage output terminal C of the AC-DC conversion circuit 828 is formed at a connection point of the first resistor R1 and a cathode of the first zener diode Z1, and a low voltage output terminal D of the AC-DC conversion circuit 828 is formed at a connection point of the second resistor R2 and an anode of the second zener diode Z2. The voltage output terminal C is connected to a positive power supply terminal of the position sensor 820, and the voltage output terminal D is connected to a negative power supply terminal of the position sensor 820. Three terminals of the switch control circuit 830 are connected to the high voltage output terminal C of the AC-DC conversion circuit 828, an output terminal H1 of the position sensor 820 and a control electrode G of the TRIAC 826 respectively. The switch control circuit 830 includes a third resistor R3, a fifth diode D5, and a fourth resistor R4 and a sixth diode D6 connected in series between the output terminal HI of the position sensor 820 and the control electrode G of the controllable bidirectional AC switch 826. An anode of the sixth diode D6 is connected to the control electrode G of the controllable bidirectional AC switch 826. One terminal of the third resistor R3 is connected to the high voltage output terminal C of the AC-DC conversion circuit 828, and the other terminal of the third resistor R3 is connected to an anode of the fifth diode D5. A cathode of the fifth diode D5 is connected to the control electrode G of the controllable bidirectional AC switch 826.

In conjunction with FIG. 6, an operational principle of the drive circuit 840 is described. In FIG. 6, Vac indicates a waveform of voltage of the AC power supply 824, and lac indicates a waveform of current flowing through the stator winding 816. Due to the inductive character of the stator winding 816, the waveform of current Iac lags behind the waveform of voltage Vac. V1 indicates a waveform of voltage between two terminals of the first zener diode Z1, V2 indicates a waveform of voltage between two terminals of the second zener diode Z2, Vdc indicates a waveform of voltage between two output terminals C and D of the AC-DC conversion circuit 828, Ha indicates a waveform of a signal output by the output terminal H1 of the position sensor 820, and Hb indicates a rotor magnetic field detected by the position sensor 820. In this embodiment, in a case that the position sensor 820 is powered normally, the output terminal HI outputs a logic high level in a case that the detected rotor magnetic field is North, or the output terminal H1 outputs a logic low level in a case that the detected rotor magnetic field is South.

In a case that the rotor magnetic field Hb detected by the position sensor 820 is North, in a first positive half cycle of the AC power supply, the supply voltage is gradually increased from a time instant t0 to a time instant t1, the output terminal H1 of the position sensor 820 outputs a high level, and a current flows through the resistor R1, the resistor R3, the diode D5 and the control electrode G and the second anode T2 of the TRIAC 826 sequentially. The TRIAC 826 is switched on in a case that a drive current flowing through the control electrode G and the second anode T2 is greater than a gate triggering current Ig. Once the TRIAC 826 is switched on, the two nodes A and B are shorted, a current flowing through the stator winding 816 in the motor is gradually increased until a large forward current flows through the stator winding 816 to drive the rotor 814 to rotate clockwise as shown in FIG. 3. Since the two nodes A and B are shorted, there is no current flowing through the AC-DC conversion circuit 28 from the time instant t1 to a time instant t2. Hence, the resistors R1 and R2 do not consume electric energy, and the output of the position sensor 820 is stopped due to no power is supplied. Since the current flowing through two anodes T1 and T2 of the TRIAC 826 is large enough (which is greater than a holding current Ihold), the TRIAC 826 is kept to be switched on in a case that there is no drive current flowing through the control electrode G and the second anode T2. In a negative half cycle of the AC power supply, after a time instant t3, a current flowing through T1 and T2 is less than the holding current Ihold, the TRIAC 826 is switched off, a current begins to flow through the AC-DC conversion circuit 828, and the output terminal HI of the position sensor 820 outputs a high level again. Since a potential at the point C is lower than a potential at the point E, there is no drive current flowing through the control electrode G and the second anode T2 of the TRIAC 826, and the TRIAC 826 is kept to be switched off. Since the resistance of the resistors R1 and R2 in the AC-DC conversion circuit 828 are far greater than the resistance of the stator winding 816 in the motor, a current currently flowing through the stator winding 816 is far less than the current flowing through the stator winding 816 from the time instant t1 to the time instant t2 and generates very small driving force for the rotor 814. Hence, the rotor 814 continues to rotate clockwise due to inertia. In a second positive half cycle of the AC power supply, similar to the first positive half cycle, a current flows through the resistor R1, the resistor R3, the diode D5, and the control electrode G and the second anode T2 of the TRIAC 826 sequentially. The TRIAC 826 is switched on again, and the current flowing through the stator winding 816 continues to drive the rotor 814 to rotate clockwise. Similarly, the resistors R1 and R2 do not consume electric energy since the two nodes A and B are shorted. In the next negative half cycle of the power supply, the current flowing through the two anodes T1 and T2 of the TRIAC 826 is less than the holding current Ihold, the TRIAC 826 is switched off again, and the rotor continues to rotate clockwise due to the effect of inertia.

At a time instant t4, the rotor magnetic field Hb detected by the position sensor 820 changes to be South from North, the AC power supply is still in the positive half cycle and the TRIAC 826 is switched on, the two nodes A and B are shorted, and there is no current flowing through the AC-DC conversion circuit 828. After the AC power supply enters the negative half cycle, the current flowing through the two anodes T1 and T2 of the TRIAC 826 is gradually decreased, and the TRIAC 826 is switched off at a time instant t5. Then the current flows through the second anode T2 and the control electrode G of the TRIAC 826, the diode D6, the resistor R4, the position sensor 820, the resistor R2 and the stator winding 816 sequentially. As the drive current is gradually increased, the TRIAC 826 is switched on again at a time instant t6, the two nodes A and B are shorted again, the resistors RI and R2 do not consume electric energy, and the output of the position sensor 820 is stopped due to no power is supplied. There is a larger reverse current flowing through the stator winding 816, and the rotor 814 continues to be driven clockwise since the rotor magnetic field is South. From the time instant t5 to the time instant t6, the first zener diode Z1 and the second zener diode Z2 are switched on, hence, there is a voltage output between the two output terminals C and D of the AC-DC conversion circuit 828. At a time instant t7, the AC power supply enters the positive half cycle again, the TRIAC 826 is switched off when the current flowing through the TRIAC 826 crosses zero, and then a voltage of the control circuit is gradually increased. As the voltage is gradually increased, a current begins to flow through the AC-DC conversion circuit 828, the output terminal H1 of the position sensor 820 outputs a low level, there is no drive current flowing through the control electrode G and the second anode T2 of the TRIAC 826, hence, the TRIAC 826 is switched off. Since the current flowing through the stator winding 816 is very small, nearly no driving force is generated for the rotor 814. At a time instant t8, the power supply is in the positive half cycle, the position sensor outputs a low level, the TRIAC 826 is kept to be switched off after the current crosses zero, and the rotor continues to rotate clockwise due to inertia. According to an embodiment of the present invention, the rotor may be accelerated to be synchronized with the stator after rotating only one circle after the stator winding is energized.

In the embodiment of the present invention, by taking advantage of a feature of a TRIAC that the TRIAC is kept to be switched on although there is no drive current flowing though the TRIAC once the TRIAC is switched on, it is avoided that a resistor in the AC-DC conversion circuit still consumes electric energy after the TRIAC is switched on, hence, the utilization efficiency of electric energy can be improved significantly.

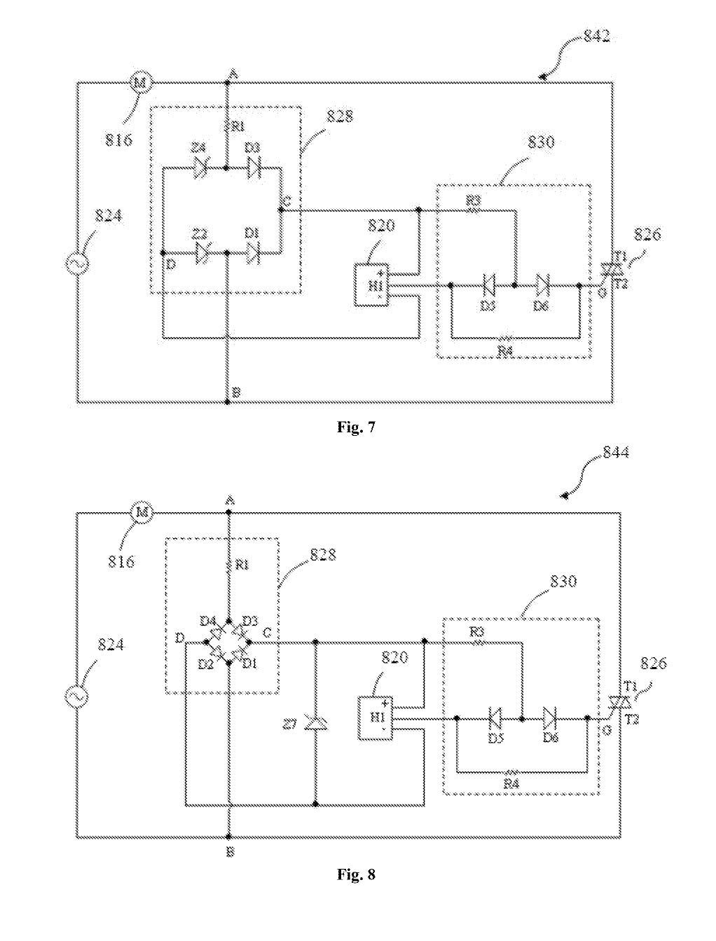

FIG. 7 shows a circuit diagram of a drive circuit 842 for a synchronous motor according to an embodiment of the present disclosure. The stator winding 816 of the synchronous motor is connected in series with the AC power supply 824 between the two nodes A and B. A first anode T1 of the TRIAC 826 is connected to the node A, and a second anode T2 of the TRIAC 826 is connected to the node B. The AC-DC conversion circuit 828 is connected in parallel with the TRIAC 826 between the two nodes A and B. An AC between the two nodes A and B is converted by the AC-DC conversion circuit 828 into a low voltage DC, preferably, a low voltage ranging from 3V to 18V. The AC-DC conversion circuit 828 includes a first resistor R1 and a full wave bridge rectifier connected in series between the two nodes A and B. The full wave bridge rectifier includes two rectifier branches connected in parallel, one of the two rectifier branches includes a first diode D1 and a third diode D3 reversely connected in series, and the other of the two rectifier branches includes a second zener diode Z2 and a fourth zener diode Z4 reversely connected in series, the high voltage output terminal C of the AC-DC conversion circuit 828 is formed at a connection point of a cathode of the first diode Dl and a cathode of the third diode D3, and the low voltage output terminal D of the AC-DC conversion circuit 828 is formed at a connection point of an anode of the second zener diode Z2 and an anode of the fourth zener diode Z4. The output terminal C is connected to a positive power supply terminal of the position sensor 820, and the output terminal D is connected to a negative power supply terminal of the position sensor 820. The switch control circuit 30 includes a third resistor R3, a fourth resistor R4, and a fifth diode D5 and a sixth diode D6 reversely connected in series between the output terminal H1 of the position sensor 820 and the control electrode G of the controllable bidirectional AC switch 826. A cathode of the fifth diode D5 is connected to the output terminal H1 of the position sensor, and a cathode of the sixth diode D6 is connected to the control electrode G of the controllable bidirectional AC switch. One terminal of the third resistor R3 is connected to the high voltage output terminal C of the AC-DC conversion circuit, and the other terminal of the third resistor R3 is connected to a connection point of an anode of the fifth diode D5 and an anode of the sixth diode D6. Two terminals of the fourth resistor R4 are connected to a cathode of the fifth diode D5 and a cathode of the sixth diode D6 respectively.

FIG. 8 shows a circuit diagram of a drive circuit 844 for a synchronous motor according to a further embodiment of the present invention. The drive circuit 844 is similar to the drive circuit 842 in the previous embodiment and, the drive circuit 844 differs from the drive circuit 842 in that, the zener diodes Z2 and Z4 in the drive circuit 842 are replaced by general diodes D2 and D4 in the rectifier of the drive circuit 844. In addition, a zener diode Z7 is connected between the two output terminals C and D of the AC-DC conversion circuit 828 in the drive circuit 844.

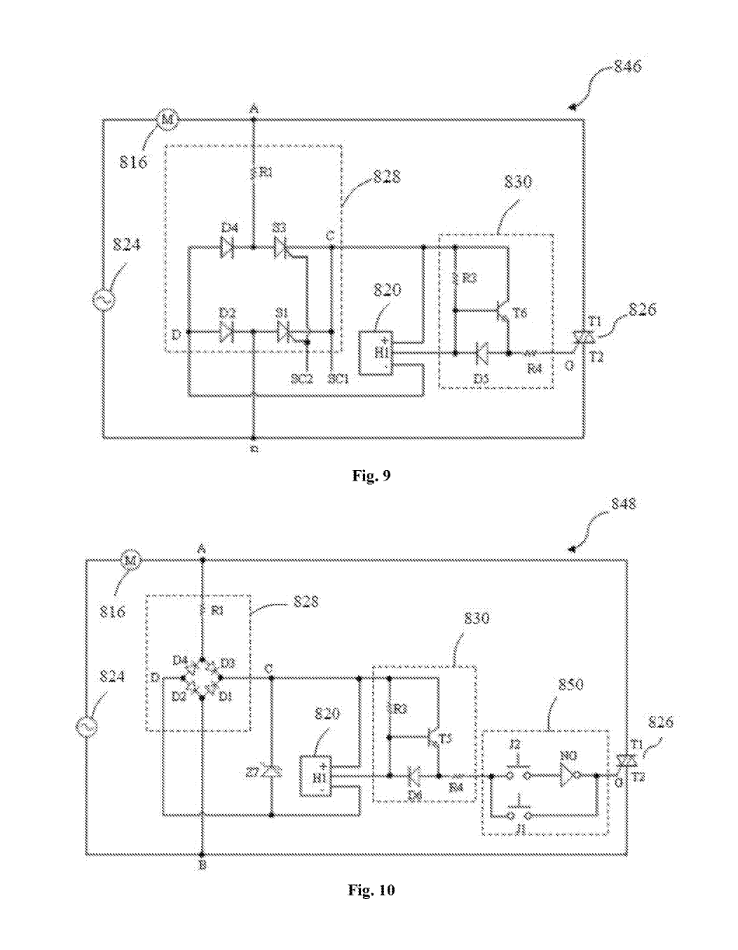

FIG. 9 shows a circuit diagram of a drive circuit 846 for a synchronous motor according to further embodiment of the present invention. The stator winding 816 of the synchronous motor is connected in series with the AC power supply 824 between the two nodes A and B. A first anode Ti of the TRIAC 826 is connected to the node A, and a second anode T2 of the TRIAC 826 is connected to the node B. The AC-DC conversion circuit 828 is connected in parallel with the TRIAC 826 between the two nodes A and B. An AC voltage between the two nodes A and B is converted by the AC-DC conversion circuit 828 into a low voltage DC, preferably, a low voltage ranging from 3V to 18V. The AC-DC conversion circuit 828 includes a first resistor R1 and a full wave bridge rectifier connected in series between the two nodes A and B. The full wave bridge rectifier includes two rectifier branches connected in parallel, one of the two rectifier branches includes two silicon control rectifiers S1 and S3 reversely connected in series, and the other of the two rectifier branches includes a second diode D2 and a fourth diode D4 reversely connected in series. The high voltage output terminal C of the AC-DC conversion circuit 828 is formed at a connection point of a cathode of the silicon control rectifier S1 and a cathode of the silicon control rectifier S3, and the low voltage output terminal D of the AC-DC conversion circuit 828 is formed at a connection point of an anode of the second diode D2 and an anode of the fourth diode D4. The output terminal C is connected to a positive power supply terminal of the position sensor 820, and the output terminal D is connected to a negative power supply terminal of the position sensor 820. The switch control circuit 830 includes a third resistor R3, an NPN transistor T6, and a fourth resistor R4 and a fifth diode D5 connected in series between the output terminal H1 of the position sensor 820 and the control electrode G of the controllable bidirectional AC switch 826. A cathode of the fifth diode D5 is connected to the output terminal Hl of the position sensor. One terminal of the third resistor R3 is connected to the high voltage output terminal C of the AC-DC conversion circuit, and the other terminal of the third resistor R3 is connected to the output terminal H1 of the position sensor. A base of the NPN transistor T6 is connected to the output terminal H1 of the position sensor, an emitter of the NPN transistor T6 is connected to an anode of the fifth diode D5, and a collector of the NPN transistor T6 is connected to the high voltage output terminal C of the AC-DC conversion circuit.

In this embodiment, a reference voltage may be input to the cathodes of the two silicon control rectifiers S1 and S3 via a terminal SC1, and a control signal may be input to control terminals of S1 and S3 via a terminal SC2. The rectifiers S1 and S3 are switched on in a case that the control signal input from the terminal SC2 is a high level, or are switched off in a case that the control signal input from the terminal SC2 is a low level. Based on the configuration, the rectifiers S1 and S3 may be switched between a switch-on state and a switch-off state in a preset way by inputting the high level from the terminal SC2 in a case that the drive circuit operates normally. The rectifiers S1 and S3 are switched off by changing the control signal input from the terminal SC2 from the high level to the low level in a case that the drive circuit fails. In this case, the TRIAC 826, the conversion circuit 828 and the position sensor 820 are switched off, to ensure the whole circuit to be in a zero-power state.

FIG. 10 shows a circuit diagram of a drive circuit 848 for a synchronous motor according to another embodiment of the present invention. The drive circuit 848 is similar to the drive circuit 846 in the previous embodiment and, the drive circuit 848 differs from the drive circuit 846 in that, the silicon control diodes S1 and S3 in the drive circuit 846 are replaced by general diodes D1 and D3 in the rectifier of the drive circuit 848, and a zener diode Z7 is connected between the two terminals C and D of the AC-DC conversion circuit 828. In addition, in the drive circuit 848 according to the embodiment, a preset steering circuit 850 is disposed between the switch control circuit 30 and the TRIAC 826. The preset steering circuit 850 includes a first jumper switch J1, a second jumper J2 switch and an inverter NG connected in series with the second jumper switch J2. Similar to the drive circuit 846, in this embodiment, the switch control circuit 830 includes the resistor R3, the resistor R4, the NPN transistor T5 and the diode D6. One terminal of the resistor R4 is connected to a connection point of an emitter of the transistor T5 and an anode of the diode D6, and the other terminal of the resistor R4 is connected to one terminal of the first jumper switch J1, and the other terminal of the first jumper switch J1 is connected to the control electrode G of the TRIAC 826, and the second jumper switch J2 and the inverter NG connected in series are connected across two terminals of the first jumper switch J1. In this embodiment, when the first jumper switch J1 is switched on and the second jumper switch J2 is switched off, similar to the above embodiments, the rotor 814 still starts clockwise; when the second jumper switch J2 is switched on and the first jumper switch J1 is switched off, the rotor 814 starts counterclockwise. In this case, a starting direction of the rotor in the motor may be selected by selecting one of the two jumper switches to be switched on and the other to be switched off. Therefore, in a case that a driving motor is needed to be supplied for different applications having opposite rotational directions, it is just needed to select one of the two jumper switches J1 and J2 to be switched on and the other to be switched off, and no other changes need to be made to the drive circuit, hence, the drive circuit according to this embodiment has good versatility.

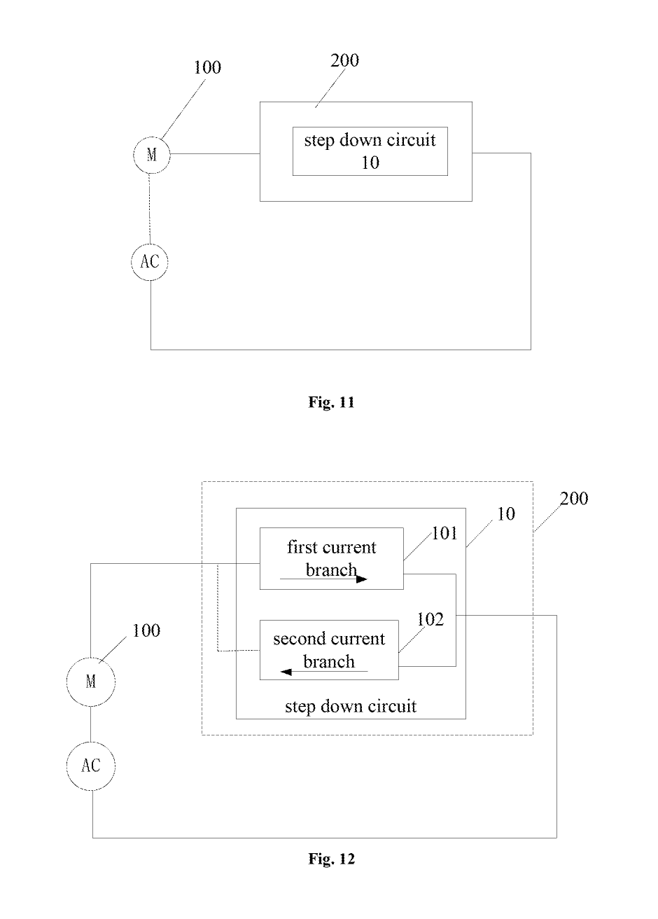

Reference is made to FIG. 11 and FIG. 12. Structural diagrams of a motor assembly according to an embodiment of the present disclosure are shown. The motor assembly can include a motor 100 and a motor driving circuit 200. Specifically, the motor driving circuit 200 includes a step down circuit 10, and the step down circuit 10 includes a first current branch 101 and a second current branch 102 which are turned on selectively.

Preferably, the first current branch 101 and the second current branch 102 according to the embodiment of the present disclosure are unidirectional current branches and are configured to allow currents having opposite directions to pass through. As shown by arrows in FIG. 12, a current in the first current branch 101 flows from left to right, and a current in the second current branch 102 flows from right to left. Of course, the current in the first current branch 101 may flow from right to left, and in this case, the current in the second current branch 102 is required to flow from left to right, that is, the currents in the first current branch 101 and the second current branch 102 flow in opposite directions.

On the basis of the above embodiment, in an embodiment of the present disclosure, a voltage drop generated by the first current branch 101 is equal to that generated by the second current branch 102, and the present disclosure is not limited hereto and depends on specific situations.

Preferably, the first current branch 101 includes a power transistor. When the first current branch 101 is turned on, a current thereof flows through the power transistor in a first direction, and the power transistor may be enabled to operate in an amplifier mode so as to allow the first current branch to generate a required voltage drop. The second current branch may also include a power transistor. When the second current branch 102 is turned on, a current thereof flows through the power transistor in a second direction opposite to the first direction, and the power transistor may also be enabled to operate in an amplifier mode so as to allow the second current branch to generate a required voltage drop. Moreover, the flow direction of a current in the power transistor in the second current branch 102 is opposite to the flow direction of a current in the power transistor in the first current branch 101.

In the embodiments of the present disclosure, when the first current branch or the second current branch is turned on, the power transistor thereof is turned on and operates in the amplifier mode, a base current is very low, and an equivalent resistor between the collector and the emitter is very large, therefore, a very large voltage drop will be generated between the collector and the emitter so as to achieve the required voltage dropping.

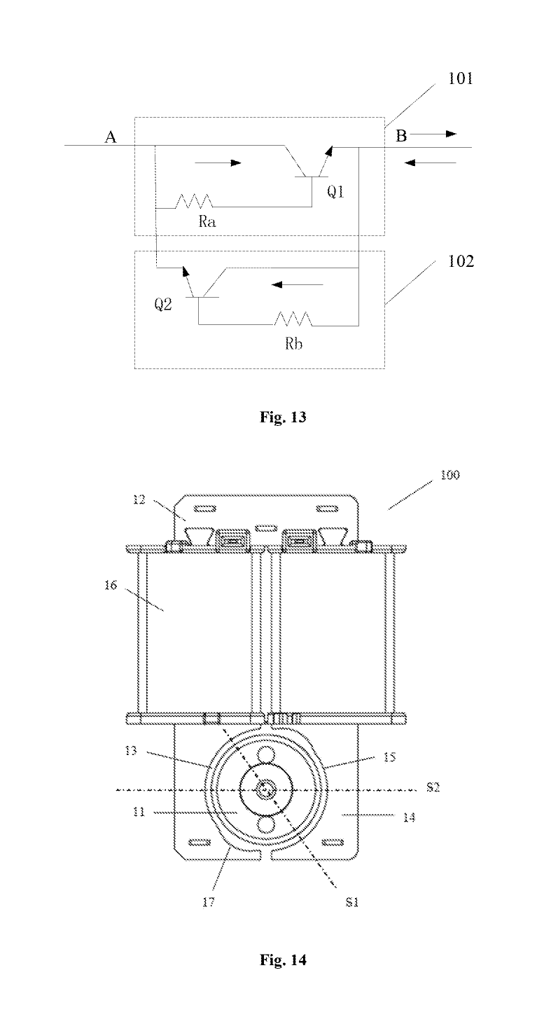

FIG. 13 shows a specific implementation of a step down circuit 10 according to an embodiment of the present disclosure. The step down circuit 10 has a first terminal A and a second terminal B. The first current branch 101 can include a first switch transistor Q1 and a first resistor Ra. A current input terminal (i.e., a collector of the first switch transistor Q1) of the first switch transistor Q1 is electrically connected to the first terminal A, a current output terminal (i.e., an emitter of the first switch transistor Q1) of the first switch transistor Q1 is electrically connected to the second terminal B, a control terminal (i.e., a base of the first switch transistor Q1) of the first switch transistor Q1 is electrically connected to a terminal of the first resistor Ra, and the other terminal of the first resistor Ra is electrically connected to the current input terminal (i.e., the first terminal A of the step down circuit 10).

The second current branch 102 can include a second switch transistor Q2 and a second resistor Rb. A current input terminal (i.e., a collector of the second switch transistor Q2) of the second switch transistor Q2 is electrically connected to the second terminal B, a current output terminal (i.e., an emitter of the second switch transistor Q2) of the second switch transistor Q2 is electrically connected to the first terminal A, a control terminal (i.e., a base of the second switch transistor Q2) of the second switch transistor Q2 is electrically connected to a terminal of the second resistor Rb, and the other terminal of the second resistor Rb is electrically connected to the current input terminal (i.e., the second terminal B of the step down circuit 10) of the second switch transistor.

It should be noted that, in the embodiments of the present disclosure, it is preferred that a voltage drop between the current input terminal and the current output terminal of the first switch transistor is set to be equal to a voltage drop between the current input terminal and the current output terminal of the second switch transistor. Of course, the voltage drop of the first current branch may be set to be different from that of the second current branch based on actual requirements of the circuit, which is not limited in the present disclosure and depends on specific situations.

In any one of the above embodiments, optionally, the motor 100 is connected with the step down circuit 10 in series, as shown in FIG. 11. In a specific application example of the present disclosure, the motor 100 can be a synchronous motor. It can be understood that, the step down circuit in the motor driving circuit 200 according to the present disclosure is applicable to a synchronous motor as well as other types of alternating current permanent magnet motors. The synchronous motor can include a stator and a rotor rotatable relative to the stator. The stator includes a stator core and a stator winding wound on the stator core. The stator core may be made of soft magnetic materials such as pure iron, cast iron, cast steel, electrical steel, silicon steel. The rotor includes a permanent magnet, and the rotor operates at a constant rotational speed of 60 f/p revs/min during a steady state when the stator winding is connected in series with an alternating current power supply, where the f is a frequency of the alternating current power supply and the p is the number of pole pairs of the rotor.

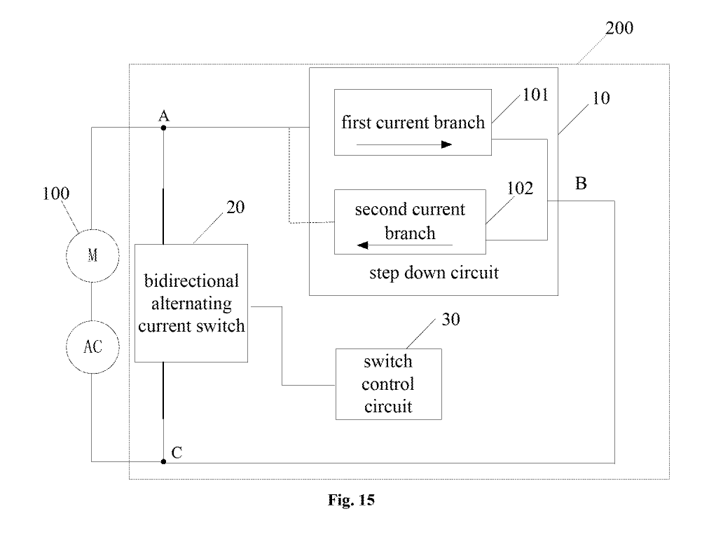

On the basis of the above embodiments, in an embodiment of the present disclosure, as shown in FIG. 15, the motor driving circuit 200 further includes a bidirectional alternating current switch 20 and a switch control circuit 30 which are connected in series with the motor 100. A control output terminal of the switch control circuit 30 is electrically connected to a control terminal of the bidirectional alternating current switch 20, so as to turn on or turn off the bidirectional alternating current switch 20 in a pre-determined manner. In an embodiment, the switch control circuit 30 may be implemented by a microcontroller.

The bidirectional alternating current switch 20 can be a triac (TRIAC), two anodes of the triac are connected to a node A and a node C respectively, and a control terminal of the triac is connected to the switch control circuit. It can be understood that the controllable bidirectional alternating current switch can be an electronic switch, which allows currents to flow in two directions, consisting of one or more of a metal-oxide semiconductor field effect transistor, a silicon-controlled rectifier, bidirectional triode thyristor, insulated gate bipolar transistor, bipolar junction transistor, thyristor and optocoupler. For example, two metal-oxide semiconductor field effect transistors, two silicon-controlled rectifiers, two insulated gate bipolar transistors, and two bipolar junction transistors.

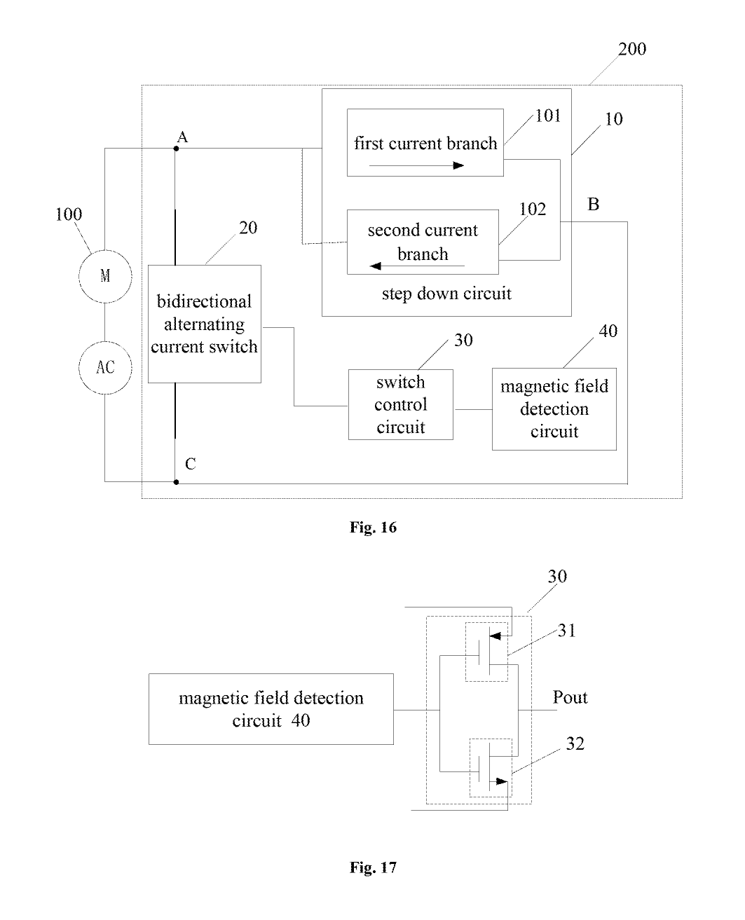

On the basis of the above embodiments, in an embodiment of the present disclosure, as shown in FIG. 16, the motor driving circuit 200 further includes a magnetic field detection circuit 40 to detect a magnetic field of a rotor of the motor 100 and output corresponding magnetic field detection information to the switch control circuit 30.

Specifically, in an embodiment of the present disclosure, the magnetic field detection circuit 40 includes a magnetic field detection element to detect the magnetic field of the rotor and output an electric signal, a signal processing unit to amplify and descramble the electric signal, and an analog-digital converting unit to convert the amplified and descrambled electric signal into the magnetic field detection information. For an application to only identify a polarity of the magnetic field of the rotor, the magnetic field detection information may be a switch-type digital signal. The magnetic field detection element may be preferably a Hall plate.

In the above embodiments, the switch control circuit 30 can operate, at least based on the magnetic field detection information, in at least one of a first state, in which a drive current flows from the control output terminal of the switch control circuit 30 to the control terminal of the bidirectional alternating current switch 20, and a second state, in which a drive current flows from the control terminal of the bidirectional alternating current switch 20 to the control output terminal of the switch control circuit 30. In a preferred embodiment, the switch control circuit 30 can switch between the first state and the second state. It should be noted that, in the embodiments of the present disclosure, the switch control circuit 30 is not limited to switch to the other state immediately after one state is over, and may be switch to the other state in a certain time interval after one state ends. In a preferred application example, there is no output in the control output terminal of the switch control circuit 30 in the time interval between switching of the two states.

On the basis of the above embodiments, in an embodiment of the present disclosure, the switch control circuit 30 can include a first switch transistor and a second switch transistor.

The first switch transistor and the control output terminal are connected in the first current path, the second switch transistor and the control output terminal are connected in the second current path having a direction opposite to that of the first current path, and the first switch transistor and the second switch transistor are turned on selectively based on the magnetic field detection information. Preferably, the first switch transistor may be a triode, and the second switch transistor may be a triode or a diode, which are not limited in the present disclosure and depend on situations.

Specifically, in an embodiment of the present disclosure, as shown in FIG. 17, the first switch 31 and the second switch 32 are a pair of complementary semiconductor switches. The first switch 31 is turned on at a low level, and the second switch 32 is turned on at a high level. The first switch 31 and the control output terminal Pout are connected in a first current path; and the second switch 32 and the control output terminal Pout are connected in a second current path. A control terminal of the first switch 31 and a control terminal of the second switch 32 are both connected to the magnetic field detection circuit 40. A current input terminal of the first switch 31 is electrically connected to a high voltage (such as a direct current power supply), a current output terminal of the first switch 31 is electrically connected to a current input terminal of the second switch 32, and a current output terminal of the second switch 32 is electrically connected to a low voltage (such as the ground). When the magnetic field detection information outputted by the magnetic field detection circuit 40 is at a low level, the first switch 31 is turned on, the second switch 32 is turned off, and a drive current flows from the high voltage to the external through the first switch 31 and the control output terminal Pout. And when the magnetic field detection information outputted by the magnetic field detection circuit 40 is at a high level, the second switch 32 is turned on, the first switch 31 is turned off, and a drive current flows from the control terminal of the bidirectional alternating current switch 20 to the control output terminal Pout and flows through the second switch 32 to the low voltage. Preferably, in an embodiment of the present disclosure, the first switch 31 in the example shown in FIG. 17 is a p-type metal-oxide semiconductor field effect transistor (P-type MOSFET), and the second switch 32 is an n-type metal-oxide semiconductor field effect transistor (N-type MOSFET). It can be understood that, in other embodiments, the first switch and the second switch may be other types of semiconductor switches, such as junction field effect transistors (JFET) or metal semiconductor field effect transistors (MESFET), which are not limited in the present disclosure.

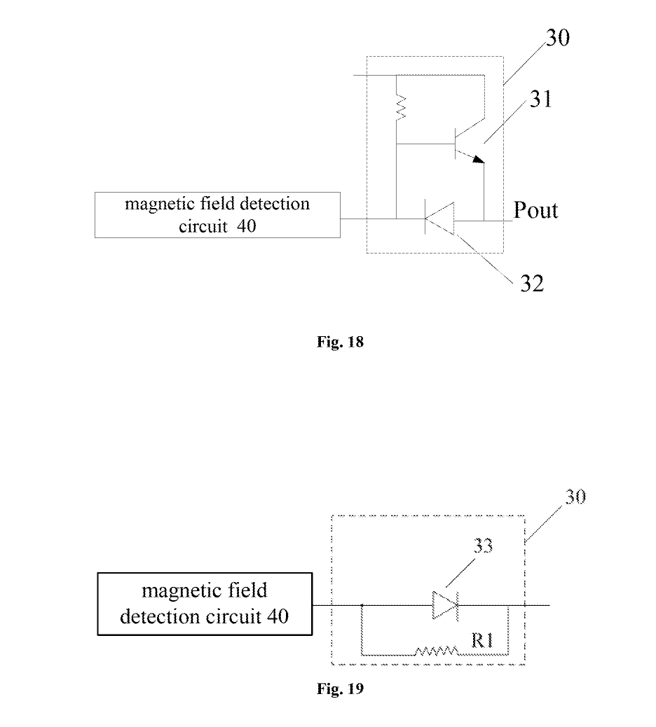

In another embodiment of the present disclosure, as shown in FIG. 18, the first switch 31 is a switch turned on at a high level, the second switch 32 is a diode. A control terminal of the first switch 31 and a cathode of the second switch 32 are electrically connected to the magnetic field detection circuit 40. A current input terminal of the first switch 31 is connected to an external alternating current power supply, and a current output terminal of the first switch 31 and an anode of the second switch 32 are both electrically connected to the control output terminal Pout. The first switch 31 and the control output terminal Pout are connected in a first current path, and the control output terminal Pout, the second switch 32 and the magnetic field detection circuit 40 are connected in a second current path. When the magnetic field detection information outputted by the magnetic field detection circuit 40 is at a high level, the first switch 31 is turned on, the second switch 32 is turned off, and a drive current flows from external alternating current power supply, passes through the first switch 31 and the control output terminal Pout and flows to the external. And when the magnetic field detection information outputted by the magnetic field detection circuit 40 is at a low level, the second switch 32 is turned on, the first switch 31 is turned off, and a drive current flows from the control terminal of the bidirectional alternating current switch 20 to the control output terminal Pout and flows through the second switch 32. It can be understood that, in other embodiments of the present disclosure, the first switch 31 and the second switch 32 may be of other structures, which are not limited in the present disclosure and depend on specific situations.

In another embodiment of the present disclosure, the switch control circuit 30 can include a first current path in which a current flows from the control output terminal Pout to the external, a second current path in which a current flows from the control output terminal Pout to the internal, and a switch connected in one of the first current path and the second current path. There is no switch in the other one of the first current path and the second current path, and the switch control circuit 30 is controlled by the magnetic field detection information outputted by the magnetic field detection circuit 40, so as to turn on the first current path and the second current path selectively.

In a specific implementation, as shown in FIG. 19, the switch control circuit 30 includes an unidirectional switch 33, the unidirectional switch 33 and the control output terminal Pout are connected in a first current path, a current input terminal of the unidirectional switch 33 may be electrically connected to an output terminal of the magnetic field detection circuit 40, and the output terminal of the magnetic field detection circuit 40 may be further connected, through a resistor R1, to the control output terminal Pout in a second current path having a direction opposite to that of the first current path. The unidirectional switch 33 is turned on when a magnetic field induction signal is at a high level, and a drive current flows to the external through the unidirectional switch 33 and the control output terminal Pout. The unidirectional switch 33 is turned off when the magnetic field induction signal is at a low level, a drive current flows from the external to the control output terminal Pout and flows through the resistor R1 and the magnetic field detection circuit 40. As an alternative, the resistor R1 in the second current path may be replaced with another unidirectional switch connected in anti-parallel with the unidirectional switch 33. In this way, a drive current flowing from the control output terminal is relatively balanced with a drive current flowing to the control output terminal, which is not limited in the present disclosure.

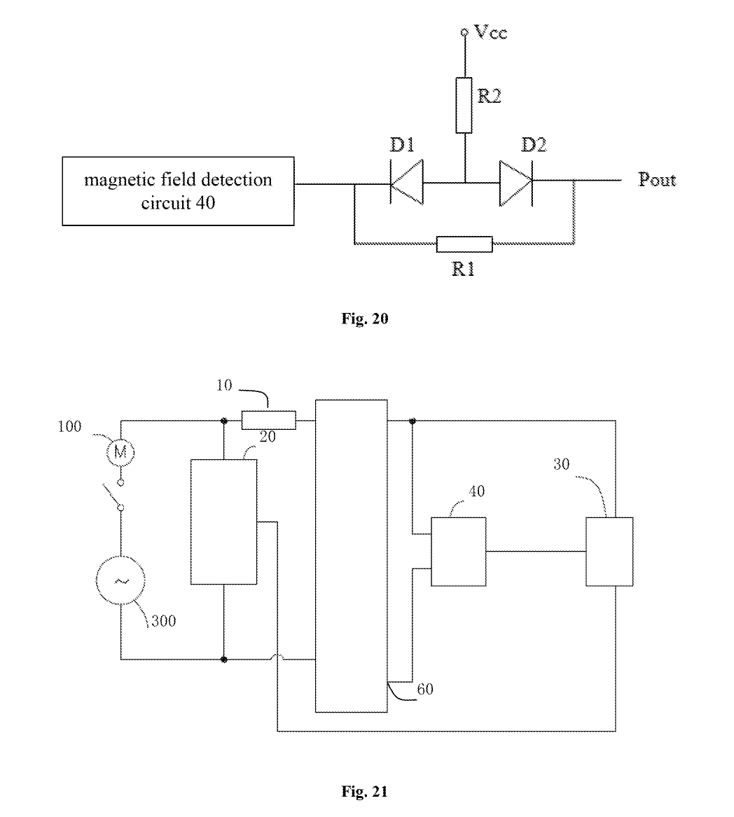

In another specific implementation, as shown in FIG. 20, the switch control circuit 30 includes diodes D1 and D2 connected in anti-series between the output terminal of the magnetic field detection circuit 40 and the control output terminal Pout, a resistor R1 connected in parallel with the series-connected diodes D1 and D2, and a resistor R2 connected between, a common terminal of the diodes D1 and D2, and an external power supply Vcc. A cathode of the diode D1 is connected to the output terminal of the magnetic field detection circuit 40. The diode D1 is controlled by the magnetic field detection circuit 40. When the magnetic field detection circuit 40 outputs a high level, the diode Dl is turned off, and a drive current flows from the power supply Vcc, passes through the resistor R2 and the diode D2, and flows from the control output terminal Pout to the external. When the magnetic field detection circuit 40 outputs a low level, a drive current flows from the external to the control output terminal Pout, and flows through the resistor R1 and the magnetic field detection circuit 40.

In an embodiment of the present disclosure, as shown in FIG. 16, the motor 100 is connected in series with the bidirectional alternating current switch 20 across an external alternating current power supply 300. The switch control circuit 30 can switch between the first state and the second state based on a change of polarity of the alternating current power supply 300 and the magnetic field detection information.

In an embodiment of the present disclosure, the switch control circuit 30 can allow the control output terminal to have a drive current to flow when the alternating current power supply 300 is in a positive half-cycle and a polarity of the magnetic field of the rotor detected by the magnetic field detection circuit 40 is a first polarity, or when the alternating current power supply 300 is in a negative half-cycle and the polarity of the magnetic field of the rotor detected by the magnetic field detection circuit 40 is a second polarity opposite to the first polarity. There is no drive current to flow through the control output terminal when the alternating current power supply 300 is in a positive half-cycle and the polarity of the magnetic field of the rotor is the second polarity, or when the alternating current power supply 300 is in a negative half-cycle and the polarity of the magnetic field of the rotor is the first polarity. It should be noted that, when the alternating current power supply 300 is in a positive half-cycle and the magnetic field of the rotor has the first polarity or when the alternating current power supply 300 is in a negative half-cycle and the magnetic field of the rotor has the second polarity, the situation that the control output terminal has a flowing drive current may be a situation that the control output terminal has a flowing drive current for whole duration of the two cases described above, or may be a situation that the control output terminal has a flowing drive current for partial duration of the two cases described above.

In an embodiment of the present disclosure, as shown in FIG. 21, the motor driving circuit further includes a rectifying circuit 60 connected in series with the step down circuit 10. The rectifying circuit 60 can convert an alternating current signal outputted by the alternating current power supply 300 into a direct current signal.

It should be noted that, in the embodiments of the present disclosure, an input terminal of the rectifying circuit 60 may include a first input terminal and a second input terminal which are connected to the alternating current power supply 300. In the present disclosure, the case that the input terminals are connected to the alternating current power supply 300 may be a case that the input terminals are directly connected to two terminals of the alternating current power supply 300, or may be a case that the input terminals are connected in series with the motor across two terminals of the alternating current power supply 300, which is not limited in the present disclosure and depends on specific situations, as long as the rectifying circuit 60 can convert the alternating current signal outputted by the alternating current power supply 300 into the direct current signal.

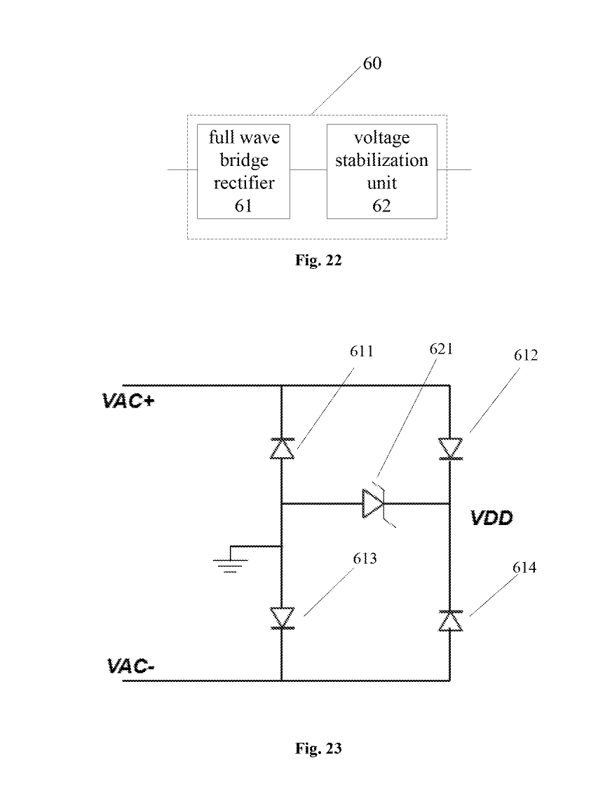

In an specific embodiment of the present disclosure, as shown in FIG. 22, the rectifying circuit 60 can include a full wave bridge rectifier 61 and a voltage stabilization unit 62 connected to the output of the full wave bridge rectifier 61. The full wave bridge rectifier 61 can to convert the alternating current outputted by the alternating current power supply 300 into the direct current, and the voltage stabilization unit 62 can stabilize the direct current signal outputted by the full wave bridge rectifier 61 within a pre-set range.

FIG. 23 shows a specific circuit of the rectifying circuit 60. The voltage stabilization unit 62 includes a Zener diode 621 connected between two output terminals of the full wave bridge rectifier 61. The full wave bridge rectifier 61 includes a first diode 611 and a second diode 612 connected in series, and a third diode 613 and a fourth diode 614 connected in series. A common terminal of the first diode 611 and the second diode 612 is electrically connected to the first input terminal VAC+, and a common terminal of the third diode 613 and the fourth diode 614 is electrically connected to the second input terminal VAC−.

An input terminal of the first diode 611 is electrically connected to an input terminal of the third diode 613 to form a grounded output terminal of the full wave bridge rectifier, and an output terminal of the second diode 612 is electrically connected to an output terminal of the fourth diode 614 to form a voltage output terminal VDD of the full wave bridge rectifier. The Zener diode 621 is connected between a common terminal of the second diode 612 and the fourth diode 614, and a common terminal of the first diode 611 and the third diode 613. It should be noted that, in the embodiments of the present disclosure, a power terminal of the switch control circuit 30 may be electrically connected to the voltage output terminal of the full wave bridge rectifier 61.

Accordingly, an application device including a motor assembly according to any one of the above embodiments is further provided. Preferably, the application device is a pump, a fan, a household appliance or a vehicle, which is not limited in the present disclosure and depends on specific situations.

On the basis of the above embodiments, in an embodiment of the present disclosure, a motor in the motor assembly is a single-phase permanent magnet brushless motor, which is not limited in the present disclosure and depends on specific situations. To sum up, a function of a conventional motor driving circuit is extended by the motor assembly according to the embodiments of the present disclosure, hence, the cost of the overall circuit is reduced and the reliability of the circuit is improved.

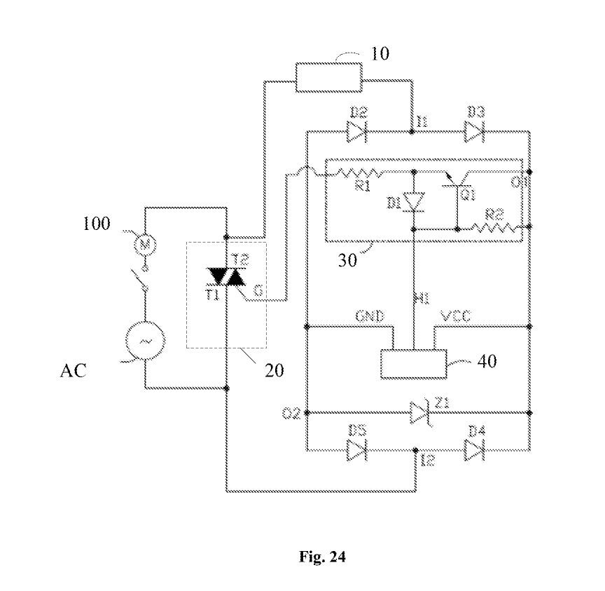

In addition, an integrated circuit is further provided according to an embodiment of the present disclosure. The integrated circuit includes a housing, a semiconductor substrate arranged inside the housing, an input port and an output port which extend out from the housing, and an electronic circuit arranged on the semiconductor substrate. As shown in FIG. 24, the electronic circuit includes a step down circuit 10, and the step down circuit includes a first current branch and a second current branch which are turned on selectively. It should be noted that, on the basis of the above embodiments, in an embodiment of the present disclosure, the step down circuit has features of a step down circuit in a motor assembly according to any one of the above embodiments.

The step down circuit according to the embodiments of the present disclosure may be integrated in the integrated circuit. A heat dissipation plate may be fixed in the housing of the integrated circuit, so that the step down circuit may dissipate heat via the heat dissipation plate and avoid damage due to a very high temperature of the internal circuit.

In an embodiment of the present disclosure, as shown in FIG. 24, the electronic circuit further includes some or all of a magnetic field detection circuit 40, a switch control circuit 30, a bidirectional alternating current switch 20 and a rectifying circuit (which includes the diodes D2, D3, D4 and D5). For structures and functions of the magnetic field detection circuit, the switch control circuit, the bidirectional alternating current switch and the rectifying circuit, reference can be made to structures and functions of a magnetic field detection circuit, a switch control circuit, a bidirectional alternating current switch and a rectifying circuit in a motor assembly according to any one of the above embodiments, which are not repeated in the present disclosure.

On the basis of any one of the above embodiments, in an embodiment of the present disclosure, a heat dissipation plate is fixed on the housing, so as to dissipate heat generated by the electronic circuit to the external environment, and avoid damage to the electronic circuit due to a very high temperature thereof.

In another embodiment, the motor may be connected in series with the bidirectional switch between a node A and a node C, and the node A and the node C may be connected to two terminals of the alternating current power supply respectively.

A motor assembly, an integrated circuit and an application device including the motor assembly are provided in the present disclosure. The motor assembly includes a motor and a motor driving circuit, the motor driving circuit includes a step down circuit, and the step down circuit includes a first current branch and a second current branch which are turned on selectively. In the motor assembly according to the embodiments of the present disclosure, the step down circuit is integrated in an application specific integrated circuit, thereby reducing the complexity and cost of the circuit.

To facilitate description, the above systems are divided into various modules based on functions and are described respectively. Of course, when implementing the present disclosure, the functions of the various modules may be implemented in one or more software and/or hardware.

It should be noted that, relational terms in the present disclosure such as the first or the second are only used to differentiate one entity or operation from another entity or operation, rather than requiring or indicating any actual relation or sequence among the entities or operations. In addition, terms such as “include”, “comprise” or any other variant are intended to be non-exclusive, so that the process, method, item or device including a series of elements not only includes the elements but also includes other elements which are not specifically listed or the inherent elements of the process, method, item or device. With no more limitations, the element restricted by the phrase “include a . . . ”does not exclude other same elements in the process, method, item or device including the element.

The above descriptions of the disclosed embodiments enable those skilled in the art to practice or use the present disclosure. Various changes to the embodiments are apparent to those skilled in the art, and general principles defined herein may be implemented in other embodiments without departing from the spirit or scope of the present disclosure. Therefore, the present disclosure is not limited to the embodiments disclosed herein, but conforms to the widest scope consistent with the principles and novel features disclosed herein.

1. A motor assembly comprising a motor and a motor driving circuit, wherein the motor driving circuit comprises a step down circuit having a first current branch and a second current branch which are turned on selectively.

2. The motor assembly according to claim 1, wherein the first current branch and the second current branch are unidirectional current branches to allow currents having opposite directions to pass through.

3. The motor assembly according to claim 2, wherein the first current branch comprises a power transistor; and the power transistor operates in an amplifier mode when the first current branch is turned on.

4. The motor assembly according to claim 1, wherein the step down circuit has a first terminal and a second terminal,
the first current branch comprises: a first switch transistor and a first resistor, a current input terminal of the first switch transistor is electrically connected to the first terminal, a current output terminal of the first switch transistor is electrically connected to the second terminal, a control terminal of the first switch transistor is electrically connected to a terminal of the first resistor, and the other terminal of the first resistor is electrically connected to the current input terminal of the first switch transistor; and
the second branch comprises: a second switch transistor and a second resistor, a current input terminal of the second switch transistor is electrically connected to the second terminal, a current output terminal of the second switch transistor is electrically connected to the first terminal, a control terminal of the second switch transistor is electrically connected to a terminal of the second resistor, and the other terminal of the second resistor is electrically connected to the current input terminal of the second switch transistor.

5. The motor assembly according to claim 4, wherein a voltage drop between the current input terminal and the current output terminal of the first switch transistor is equal to a voltage drop between the current input terminal and the current output terminal of the second switch transistor.

6. The motor assembly according to claim 1, wherein the motor is electrically coupled to the step down circuit in series.

7. The motor assembly according to claim 6, wherein the motor driving circuit further comprises a bidirectional alternating current switch and a switch control circuit which are both coupled to the motor in series, and a control output terminal of the switch control circuit is electrically coupled to a control terminal of the bidirectional alternating current switch.

8. The motor assembly according to claim 7, wherein the motor driving circuit further comprises a magnetic field detection circuit to detect a magnetic field of a rotor of the motor and output magnetic field detection information to the switch control circuit.

9. The motor assembly according to claim 8, wherein the switch control circuit is set to switch, at least based on the magnetic field detection information, between a first state in which a drive current flows from the control output terminal of the switch control circuit to the control terminal of the bidirectional alternating current switch and a second state in which a drive current flows from the control terminal of the bidirectional alternating current switch to the control output terminal of the switch control circuit.

10. The motor assembly according to claim 9, wherein the motor is coupled to the bidirectional alternating current switch in series via an external alternating current power supply, and the switch control circuit is configured to switch between the first state and the second state based on a change of a polarity of the alternating current power supply and based on the magnetic field detection information.

11. The motor assembly according to claim 9, wherein the switch control circuit comprises a first switch and a second switch, the first switch and the control output terminal are coupled in a first current path, the second switch and the control output terminal are coupled in a second current path in which a direction of a current is opposite to that in the first current path, and the first switch and the second switch are selectively turned on based on the magnetic field detection information.

12. The motor assembly according to claim 9, wherein the switch control circuit comprises a first current path in which a current flows from the control output terminal to the external, a second current path in which a current flows from the control output terminal to the internal, and a switch coupled in one of the first current path and the second current path, and the switch is controlled by the magnetic field detection information to selectively turn on the first current path and the second current path.

13. The motor assembly according to claim 10, wherein a flowing drive current is allowed by the switch control circuit when the alternating current power supply is in a positive half-cycle and the magnetic field of the rotor detected by the magnetic field detection circuit has a first polarity or when the alternating current power supply is in a negative half-cycle and the magnetic field of the rotor detected by the magnetic field detection circuit has a second polarity opposite to the first polarity, and there is no flowing drive current allowed by the control output terminal when the alternating current power supply is in a positive half-cycle and the magnetic field of the rotor has the second polarity or when the alternating current power supply is in a negative half-cycle and the magnetic field of the rotor has the first polarity.

14. The motor assembly according to claim 8, wherein the motor driving circuit further comprises a rectifying circuit coupled to step down circuit in series.

15. An integrated circuit comprising a housing, a semiconductor substrate arranged inside the housing, an input port and an output port which extend out from the housing, and an electronic circuit arranged on the semiconductor substrate, wherein the electronic circuit comprises a step down circuit having a first current branch and a second current branch which are turned on selectively.

16. The integrated circuit according to claim 15, wherein the electronic circuit further comprises some or all of a magnetic field detection circuit, a switch control circuit, a bidirectional alternating current switch and a rectifying circuit.

17. The integrated circuit according to claim 15, wherein a heat dissipation plate is fixed in the housing.

18. An application device comprising a motor assembly of claim 1.

19. The application device according to claim 18, wherein the application device is a pump, a fan, a household appliance or a vehicle.

20. The application device according to claim 18, wherein a motor in the motor assembly is a single-phase permanent magnet brushless motor.
